(19) United States
(12) Patent Application Publication
(10) Pub. No.: US 2009/0254372 A1
(43) Pub. Date: Oct. 8, 2009

(54) Medication Risk Assessment System

(76) Inventors: Samuel W. Bartholomew, III, Nashville, TN (US); Michael D. Hogue, Mt. Olive, AL (US); Joan E. Polk, Antioch, TN (US); Bradley P. Tice, Franklin, TN (US)

Correspondence Address: Raymond R. Ferrera, 1221 McKinney Street, Suite 4400, Houston, TX, 77010, US

(21) Appl. No.: 12/328,966

(22) Filed: Dec. 5, 2008

Related U.S. Application Data
(60) Provisional application No. 61/005,499, filed on Dec. 5, 2007.

(51) Int. Cl. G06Q 50/00; G06Q 99/00

(52) U.S. Cl. 705/3; 705/2; 705/10

(57) ABSTRACT

A medication risk assessment method implemented using a computer particularly adapted for a health care management or delivery organization is provided, wherein the method includes at least the steps of: providing a medication risk assessment tool to a client, wherein the medication risk assessment tool includes a questionnaire, and wherein the client maintains a relationship with a population of individuals; administering the questionnaire to the population of individuals, thereby generating questionnaire data; obtaining prescription claims data from the population of individuals; combining the questionnaire data and the prescription claims data in an electronic database, thereby generating population data; analyzing the population data according to a set of rules; ranking the analyzed data according to risk; and generating at least one report based on the ranked data.

### CROSS-REFERENCE TO RELATED APPLICATIONS

The present application claims the benefit of prior provisional application No. 61/005,499 filed Dec. 5, 2007.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to a computer implemented system or method particularly adapted for a health care management or delivery organization, and more particularly wherein the system or method processes the records of diagnosis or treatment of a patient.

2. Description of Related Art

Under the Medicare Modernization Act of 2003, a medication therapy management program (MTM) is a program of drug therapy management that may be furnished by a pharmacist and that is designed to assure targeted beneficiaries that covered Medicare part D drugs under a prescription drug plan are appropriately used to optimize therapeutic outcomes through improved medication use, and to reduce the risk of adverse events, including adverse drug interactions (42 U.S.C. % 1395w-104(c)). Under the statute, individuals targeted by MTM programs are those who 1) have multiple chronic diseases (e.g., diabetes, asthma, hypertension, hyperlipidemia, and congestive heart failure), 2) are taking multiple drugs covered under Medicare part D, and 3) are identified as likely to incur annual costs for covered part D drugs that exceed a specified level.

Although Congress mandated the provision of MTM services only to such recipients, eleven national pharmacy organizations have agreed upon a more expansive definition of MTM as a set of services provided by pharmacists or other qualified health care providers. Such services may include: performing or obtaining assessments of patient health status; formulating a medication treatment plan; selecting, initiating, modifying and/or administering medication therapy; monitoring and evaluating patient response to therapy, including safety and efficacy; performing a comprehensive medication review to identify, resolve, and prevent medication related problems, including adverse drug events; documenting the care delivered and communicating essential information to a patient's primary care providers; providing verbal education and training designed to enhance patient understanding and appropriate use of medications; providing information, support services, and resources designed to enhance patient compliance with therapeutic regimens; and coordinating and integrating MTM services within the broader health care management services provided to patients.

The MTM service model represents an improvement over pharmacy benefit management systems, which focus principally on drug-formulary management issues, and disease management systems, which focus principally on a patient's disease.

Pharmacy benefit management companies (PBMs) currently use software programs to identify certain drug-related problems. Examples of such companies include Caremark, Medco, and Pharmacare. Because PBMs manage only pharmacy claims, though, the drug-related problems identified are restricted to problems which are “drug only.” In other words, PBMs identify only high dosages, low dosages, drug-to-drug interactions, non-formulary drugs, early refills, late refills, therapeutic duplication (two dispensed drugs performing essentially the same function in the body), drag-gender interactions, and drug and dosage checks based upon age. When PBMs identify such problems, an electronic message is transmitted to the dispensing pharmacy at the time of claim submission to alert the pharmacist of the potential problem. In addition, many PBMs also send letters and/or faxes, and occasionally place telephone calls to prescribers to alert them of the potential problem. There is no guarantee, however, that these pharmacy or prescriber alerts are acted upon, and there is no consistent mechanism in place to ensure that the problem is actually resolved.

Disease management companies (DMs) partner with individual patients through their employer or health plan to provide disease-specific health and wellness education, and training. Examples of such companies include Healthways, Health Management Corporation, and Matria. The most common diseases for which DMs provide service are diabetes, asthma, smoking cessation, hypertension, multiple sclerosis, and hepatitis C. With regard to drugs, drug-related problems, and acute diseases, however, DMs do not provide consistent programs for identifying or resolving drug-related problems because their drug-related services are focused principally on ensuring that directions for use are reinforced and compliance with therapy is maintained. DM companies do often conduct health risk assessments (HRA), which are similar to the present invention; however, the present invention goes well beyond an HRA to include considerations of the 1) attitudes and beliefs about medication use, 2) attitudes and beliefs about use of the healthcare system, 3) current and past healthcare utilization, 4) current and past medical problems, and 5) risk stratification based upon nationally recognized clinical guidelines using proprietary clinical rules. HRA's are focused on opportunities for disease prevention, whereas the present invention additionally identifies existing issues with attitudes and beliefs about healthcare, as well as analyzes prior patterns related to health and health system usage, and then suggests patient-specific strategies for addressing problems and behaviors.

To address the shortcomings of PBMs and DMs, a few companies have developed methods of providing MTM services, but the services provided and the methods by which they are provided are distinct from those of the present invention. For example, Community MTM Services, Inc. (Community MTM) is a provider of MTM services and a subsidiary of the National Community Pharmacists Association (NCPA). None of these companies perform patient-level risk assessments of any type.

Community MTM contracts with PBMs and employers to provide MTM services through the NCPA's network of independent community pharmacies (approximately 24,000 across the United States). Community MTM uses documentation software that allows collection of data in a common format for the purposes of reporting back to their clients and for determining compensation to their network. The company also utilizes basic Medicare-dictated criteria to identify patients needing MTM services, and then provides this information to a local pharmacist who is willing to provide the service. Pharmacists then have an open window of time (typically several weeks) to contact the eligible patient, invite them to the pharmacy for a face-to-face MTM encounter, document the encounter using the documentation software, and transmit the information collected to Community MTM. Afterward, payment is sent to the pharmacy for providing the service. If the pharmacist determines that an identified patient is deceased and informs Community MTM of this fact, Community MTM will pay the pharmacy for assisting in updating their records via the documentation system. If the pharmacist does not act or provide service to the identified patients, then the patients continue to roll back onto the eligibility list period after period. However, Community MTM has no system in place to ensure that all eligible patients receive MTM services through their system. Community MTM does not conduct a patient-level risk assessment of any type with their clients and thus has no competing invention despite the fact they are in the same business classification (i.e. MTM administrator or provider).

Another provider of MTM services is Outcomes Pharmaceutical Health Care (Outcomes), which uses a web-based documentation and billing system in conjunction with its network of pharmacists. Outcomes identifies eligible patients based upon the Medicare criteria of multiple chronic diseases, multiple drugs covered under Medicare part D being taken, and likelihood of incurring annual costs for covered part D drugs that exceed a specified level. Outcomes has two methods of providing MTM services to eligible patients: either Outcomes identifies eligible patients and notifies a willing pharmacist MTM provider; or a pharmacist MTM provider can use the web-based Outcomes benefit package to identify a needed patient intervention, provide the MTM service, and then bill Outcomes for the service. Outcomes does not conduct a patient-level risk assessment of any type with their clients and thus has no competing invention despite the fact they are in the same business classification (i.e. MTM administrator or provider).

A third MTM service provider is excelleRx, Inc., a subsidiary of Omnicare. ExcelleRx is focused primarily on managing medications for hospice, end-of-life, and frail elderly patients. ExcelleRx owns three call centers and employs pharmacists, nurses, and a variety of technical staff to interface primarily with nurses caring for hospice and frail elderly patients. The company has developed patented clinical documentation software applications using stepped-care approaches to decision making to ensure a consistent level of service is provided by all employees. ExcelleRx was the first company to enter the market with services related to medication management. A key aspect of their delivery system is that the services provided are focused on the caregiver (usually a nurse) and problem-oriented. ExcelleRx does not conduct a patient-level risk assessment of any type with their clients and thus has no competing invention despite the fact they are in the same business classification (i.e. MTM administrator or provider).

### BRIEF SUMMARY OF THE INVENTION

The invention features, in one aspect, a method for stratifying individuals determined to need medication therapy intervention, based on the risk of adverse consequences from their medication or medications or absence thereof. The method involves the following steps: a) conducting a patient-specific medication risk assessment; b) combining the medication risk assessment with a first predictive model; c) comparing the medication risk assessment with a second predictive model; d) administering the combined medication risk assessment and first predicting model to at least one beneficiary; e) applying the second predictive model to the beneficiary identified in (d); f) applying the result of d) and e) to proprietary clinical evaluation rules; g) analyzing the data of steps d) e) and f) to produce a patient-specific report; h) using the result of step g) to categorize the at least one beneficiary as high risk, medium risk, or low risk.

In one embodiment, the medication risk assessment is a complex and comprehensive invention which stratifies the relative risk of adverse health consequences using medications and their appropriate use as a foundational tool in the risk equation. As desired, the first analysis tool may be the Profiles of Activities and Attitudes Toward Healthcare™ (The PATH Inst. Corp.). As desired further, the second predictive model may be RxGroups® (DxCG Corp.).

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 is a flow diagram of a method for assuring improved quality in medication therapy management.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

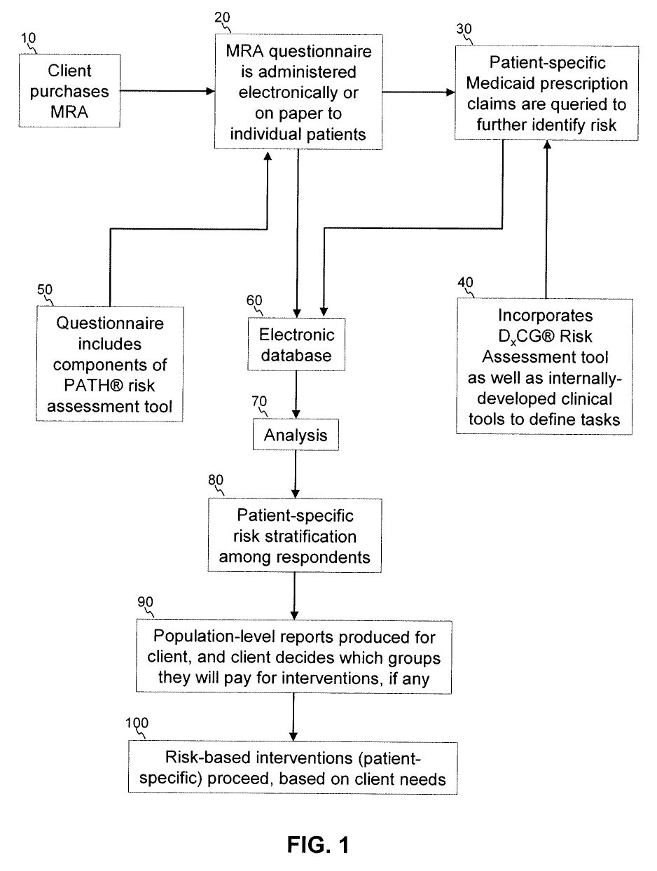

A flow diagram of a method for assuring improved quality in medication therapy management is shown in FIG. 1. The improved MTM quality is assured by identifying individuals needing a medication therapy and stratifying them based on risk. A client purchases a medication risk assessment at step (10), for example and without limitation, for its employees, patients, beneficiaries, or some other persons having a relationship with the client (referred to collectively herein as “patients” or “respondents”). A medication risk assessment questionnaire is then administered electronically and/or on paper to individual patients at step (20). The questionnaire comprises components of the PATH Institute Corporation's Profiles of Activities and Attitudes Toward Healthcare analysis tools (50). Individual questionnaire respondents' Medicaid prescription claims are queried to further identify risk at step (30). Step (30) incorporates a combination of DxCG Corporation's RxGroups® predictive models, and internally developed and proprietary patient-specific clinical evaluations (40). The results of steps (20) and (30) are entered in to an electronic database (60), analyzed at step (70), and the population of questionnaire respondents is stratified into low, medium or high risk categories or some other prioritization of risk thereof at step (80). Population-level reports are produced for the client at step (90), and the client may choose the stratified group or groups for which it will pay for interventions, if any. Intervention priorities may then assigned at step (100), depending upon the client's decision at step (90).

Preferably, this risk-based stratification process is also used in marketing, allowing clients to determine if they wish to purchase services for all beneficiaries or only those at certain levels of risk. A variation of this could be that a client may choose to manage individuals with certain categories of risk internally within the organization, and contract with others to manage the individuals at higher levels of risk. Thus, risk-based stratification tools allow for customization of product offerings to fit a specific client's needs. Risk-based stratification also facilitates assigning a patient intervention to the appropriate medication therapy management provider (i.e. registered clinical pharmacist, registered nurse, call center associate, specialized clinical pharmacist), and determining if patient interview is necessary or if non-high touch interventions are best (i.e., Internet, facsimile or letter based interventions).

To further enhance the behavior risk assessment tools described in the preceding paragraphs, a new tool called the Medication Risk Assessment (MRA) is used which is similar to a health risk assessment (commonplace in the disease and lifestyle management business models and described more fully in previous paragraphs). The MRA also assesses beneficiaries' past experiences with and beliefs about pharmacists; pharmacies; medications (both prescription and nonprescription); natural products/vitamins/nutritional supplements; and past utilization of the healthcare system. When a client chooses to conduct an MRA, the MRA questionnaire (20) is administered either electronically or in paper form. PATH'S analysis tool is incorporated (50) as an important part of the MRA questionnaire (20) as well, so as to minimize the number of questionnaires to which a beneficiary is asked to respond and to give a more complete picture of the patient's true risks regarding current and future medication use. DxCG's analysis tool is incorporated (40) into the MRA tool by utilizing past medical claims from each specific patient to further define risk of inappropriate medication use. Finally, current medication and medical data for each specific patient is obtained (30). The results of the MRA questionnaire (20) the past medical claims from each specific patient, and the current medication and medial data for each specific patient (30) are combined in an electronic database (60). The compiled data is analyzed (70) against proprietary clinical rules based upon national guidelines for medical and pharmacy care to complete the MRA process, whereupon a risk classification is generated (80) for each individual patient (i.e. low, medium, or high). Reports describing population-level data are then produced for the client (90), whereupon the client may elect to pay for interventions for specific groups, identified by their risk classification (90). Depending upon the client's decision and needs, patient-specific risk-based interventions may proceed (100).

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

1. A medication risk assessment method implemented using a computer particularly adapted for a health care management or delivery organization, wherein the method comprises the following steps:
a) providing a medication risk assessment tool to a client, wherein said medication risk assessment tool comprises a questionnaire, and wherein said client maintains a relationship with a population of individuals;
b) administering said questionnaire to said population of individuals, thereby generating questionnaire data;
c) obtaining prescription claims data from said population of individuals;
d) combining said questionnaire data and said prescription claims data in an electronic database, thereby generating population data;
e) analyzing said population data according to a set of rules;
f) ranking the data of step e) according to risk; and
g) generating at least one report based on the ranking of step f).

2. The method claim 1, wherein said questionnaire further comprises components of a first risk assessment tool, thereby creating a first set of resultant data.

3. The method of claim 2, wherein said first set of resultant data is:
stored in an electronic data base particularly adapted for a health care management or delivery organization;
analyzed according to a set of rules using a computer disposed in communication with said particularly adapted data base;
ranked according to a predetermined risk hierarchy; and
summarized in a client report.

4. The method of claim 4, further comprising a risk-based intervention based on assessed client needs.

5. The method of claim 1, wherein said prescription claims data obtained from said population of individuals further comprises components of a second risk assessment tool, thereby creating a second set of resultant data.

6. The method of claim 5, wherein said second set of resultant data is:
combined with said questionnaire data;
stored in an electronic data base particularly adapted for a health care management or delivery organization;
analyzed according to a set of rules using a computer disposed in communication with said particularly adapted data base;
ranked according to a predetermined risk hierarchy; and
summarized in a client report.

7. The method of claim 6, further comprising a risk-based intervention based on assessed client needs.

8. The method of claim 1, wherein said questionnaire data is combined with components of a first risk assessment tool, thereby creating a first set of resultant data; and said prescription claims data obtained from said population of individuals is combined with components of a second risk assessment tool, thereby creating a second set of resultant data; and said first set of resultant data and said second set of resultant data are combined to form a third set of resultant data, wherein said third set of resultant data is:
stored in an electronic data base particularly adapted for a health care management or delivery organization;
analyzed according to a set of rules using a computer disposed in communication with said particularly adapted data base;
ranked according to a predetermined risk hierarchy; and summarized in a client report.

9. The method of claim 8, further comprising a risk-based intervention based on assessed client needs.
